(19) United States
(12) Patent Application Publication
(10) Pub. No.: US 2014/0288975 A1
(43) Pub. Date: Sep. 25, 2014

(54) Determining Future Attributes of Insurance Policies Based on Analysis of Historic Funding Data

(71) Applicant: Security Mutual Life Insurance Company of New York, Binghamton, NY (US)

(72) Inventors: Kennie Lee, Vestal, NY (US); Gary W. Scofield, Stony Brook, NY (US)

(73) Assignee: Security Mutual Life Insurance Company of New York, Binghamton, NY (US)

(21) Appl. No.: 14/221,125

(22) Filed: Mar. 20, 2014

Related U.S. Application Data
(60) Provisional application No. 61/803,859, filed on Mar. 21, 2013.

(51) Int. Cl. G06Q 40/08

(52) U.S. Cl. CPC G06Q 40/08
USPC 705/4

(57) ABSTRACT

The present inventive subject matter is drawn to apparatus, systems, configurations, and methods of automatically determine an attribute (or a variable) of a life insurance policy based on historic funding data of a policy. In one aspect of the invention, a system for determining a future premium of a life insurance policy is presented.

This application claims priority to U.S. Provisional Application 61/803,859 filed on Mar. 21, 2013. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The present invention relates to premiums and interest rates for life insurance products.

### BACKGROUND

The following description includes information that may be useful in understanding the present invention. It is not an admission that any of the information provided herein is prior art or relevant to the presently claimed invention, or that any publication specifically or implicitly referenced is prior art.

Life insurance is a contract between the policyholder and the insurer (e.g., insurance carrier) in which the insurer promises to pay an amount of money upon the death of an insured person. The insured and the policyholder can be, but are not necessarily, the same person. The policy usually requires the policyholder to pay an amount of money periodically (e.g., every month, every year, etc.) that covers the cost of insurance (also known as the premium) in order to keep a life insurance policy in force.

The way in which life insurance policy premium is calculated has been unchanged for many years. Other than the benefits amount and policy term, life insurance carriers usually look at an insured's attributes (e.g., age, gender, tobacco use) to predict the insured's life expectancy in determining a life insurance policy premium for the insured.

Efforts have been made in further price differentiating different life insurance policies using other variables. For example U.S. Patent Publication 2005/0060209 to Hill et al. entitled “Method and System for Insuring Longer Than Expected Lifetime”, filed Oct. 12, 2004 discloses a method to establish a price to charge for longevity insurance coverage based on amount of coverage requested, premium payment pattern (payment schedule) selected by the insured, the life expectancy of the insured, expected investment return on invested assets, expenses, profit and cost of capital charges. U.S. Patent Publication 2010/0145735 to Kendall et al. entitled “System for Appraising Life Insurance and Annuities”, filed Nov. 23, 2009 discloses a universal life insurance product for which a premium is calculated based on current market interest rate.

However, these known factors or variables are determined at the time that the policy becomes effective and do not consider what happens to the policy holder or insured after the policy becomes effective. Thus, there is still a need for an improved method for determining premiums for life insurance policies.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY OF THE INVENTION

The present inventive subject matter is drawn to apparatus, systems, configurations, and methods of automatically determine an attribute (or a variable) of a life insurance policy based on historic funding data of a policy. In one aspect of the invention, a system for determining a future premium of a life insurance policy is presented.

In some embodiments, the system for determining a future premium of a life insurance policy may include a premium analysis module. The premium analysis module may be configured to analyze historic funding data associated with the life insurance policy. In other embodiments, the premium analysis module may also be configured to compute the future premium for the life insurance policy based in part on the analysis of the historic funding data. In yet other embodiments, the premium analysis module may configure an output device to present the computed future premium to a user.

In some embodiments, the life insurance policy may be associated with a funding account. In these embodiments, the historic funding data for the life insurance policy may contain the balances of the life insurance policy's funding account at different points in time. The premium analysis module may be enabled to compare a current one of the balances of the life insurance policy's funding account with a predetermined current benchmark funding level. In yet other embodiments, the premium analysis module may be further enabled to compute a discount to the future premium when the current balance is equal to or above the current benchmark funding level.

In some embodiments, the premium analysis module may be enabled to compute a surcharge to the future premium when the current balance is below the current benchmark funding level. The current benchmark funding level may be predetermined based on at least one characteristic of an insured of the life insurance policy. In some embodiments, the current benchmark funding level may be determined based on the gender or the age of the insured. The benchmark funding level may be determined based on the tobacco use level or on the general health status of the insured, in other embodiments.

In some embodiments, the current benchmark funding level may be predetermined based on at least one attribute of the life insurance policy. The benefit amount of the life insurance may be one of the attributes upon which the current benchmark funding level may be predetermined, in some of these embodiments.

In some embodiments, the premium analysis module may be enabled to compare the balances of the life insurance policy's funding account to many benchmark funding levels that are pre-determined for the life insurance policy. These benchmark funding levels may represent expected funding levels at different times during a term of the life insurance policy. The premium analysis module may be further enabled to generate trend data based on the historic funding data, in other embodiments. In these embodiments, the future premium may be computed based in part on the generated trend data.

In some embodiments, the system for determining a future premium of a life insurance policy may further include a database storing the historic funding data of the life insurance policy and historic funding data of a second life insurance policy. The life insurance policy and the second life insurance policy may have the same policyholder. In these embodiments, the premium analysis module may be enabled to analyze the historic funding data of the second life insurance policy and to determine the future premium based in part on the analysis of historic funding data of the life insurance policy and the analysis of historic funding data of the second life insurance policy. The life insurance policy and the second life insurance policy may have different policyholders, some other embodiments.

In another aspect of the invention, a system for determining a future interest rate of a life insurance policy is presented. In some embodiments, the system for determining a future interest rate of a life insurance policy may include an interest rate analysis module. The interest rate analysis module may be enabled to analyze the historic funding data associated with the life insurance policy. The interest rate analysis module may also be enabled to compute the interest rate for the life insurance policy based in part on the analysis of the historic funding data. Further, the interest rate analysis module may be enabled to present the computed future interest rate to a user using an output device.

In some embodiments, the life insurance policy may be associated with a funding account. The historic funding data for the life insurance policy may include balances of the life insurance policy's funding account at different points in time. In some of these embodiments, the interest rate analysis module may compare a current one of the balances of the life insurance policy's funding account with a predetermined current benchmark funding level. In other embodiments, the interest rate analysis module may also increase (or decrease) the interest rate when the current balance is equal to or above (or below) the current benchmark funding level.

In some embodiments, the current benchmark funding level may be predetermined based on at least one characteristic of an insured of the life insurance policy. Characteristics of the insured of the life insurance policy may include any combination of the gender of the insured, the age of the insured, the tobacco use level of the insured, or the health status of the insured.

In some embodiments, the current benchmark funding level may also be predetermined based on at least one attribute of the life insurance policy. The benefit amount of the life insurance policy may be one of these attributes, in some of these embodiments.

In some embodiments, the interest rate analysis module may compare the balances of the life insurance policy's funding account to one or more benchmark funding levels that are pre-determined for the life insurance policy. Any one of the benchmark funding levels may represent expected funding levels at different times during a term of the life insurance policy.

In some embodiments, the interest rate analysis module may generate trend data based on the historic funding data. The future interest rate may be computed based in part on the generated trend data, in some of these embodiments.

In some embodiments, system for determining a future interest rate of a life insurance policy may further include a database storing the historic funding data of the life insurance policy and historic funding data of a second life insurance policy. In these embodiments, the life insurance policy and the second life insurance policy may have the same policyholder. The interest rate analysis module may analyze the historic funding data of the second life insurance policy and determine the future interest rate of the life insurance policy based in part on the analysis of historic funding data of the life insurance policy and the analysis of historic funding data of the second life insurance policy, in these embodiments.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates an example insurance management system for determining a future premium of a life insurance policy.

FIGS. 2A-C illustrate example funding data stored in a storage of an insurance management system.

FIG. 3A illustrates an example account funding history of a policy account of a typical favorable policyholder.

FIG. 3B illustrates an example account balance history of a policy account of a typical favorable policyholder.

FIG. 4A illustrates an example account funding history of a policy account where a threshold range including a ceiling and a floor value is utilized in addition to a benchmark value.

FIG. 4B illustrates an example account balance history of a policy account where a threshold range including a ceiling and a floor value is utilized in addition to a benchmark value.

FIG. 5A illustrates an example account funding history of a policy account of a typical non-favorable policyholder.

FIG. 5B illustrates an example account balance history of a policy account of a typical non-favorable policyholder.

FIG. 6A illustrates an example account funding history of a policy account where the benchmark and threshold range values are adjusted before the end of the policy term.

FIG. 6B illustrates an example account balance history of a policy account where the benchmark and threshold range values are adjusted before the end of the policy term.

### DETAILED DESCRIPTION

It should be noted that any language directed to a computer should be read to include any suitable combination of computing devices, including servers, interfaces, systems, databases, agents, peers, engines, modules, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). As used here, a processor shall mean any processing unit that comprises at least one processing core (e.g., multi-core processor, multiple processors, etc.) The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The present inventive subject matter is drawn to apparatus, systems, configurations, and methods of automatically determining and modifying an attribute (or a variable) of a life insurance policy (e.g., a future life insurance premium, a future interest rate, etc.) during the lifespan (i.e., the term) of the life insurance policy. It has been contemplated that the premium of a life insurance policy can be dynamically updated during its lifetime to reflect an updated condition of the insured and/or the policy holder. In addition to an updated status (e.g., tobacco use) of the insured, it has been contemplated that the historical funding to the insurance account (of a permanent life insurance policy) can be used to modify the life insurance policy attributes.

A permanent life insurance policy (e.g., whole life insurance, universal life insurance) is a form of life insurance policy where the policy accrues cash value. The policyholder of a permanent life insurance policy is usually required to provide periodic payments that are more than the premiums to sustain the policy (avoid lapse of coverage or abandoning of the policy). Each period payment includes two parts—a first part that is known as the premium is directed toward the cost of the insurance policy and a second part payment collected minus the premium goes into a cash value account for the policyholder, from which the policyholder can withdraw, borrow, or retrieve, subsequently if necessary. In some of these policies, the cash value amount allows the policyholder to arbitrarily pay any amount of money to “fund” the policy as long as the policy's cash value is sufficient to pay for the cost of insurance.

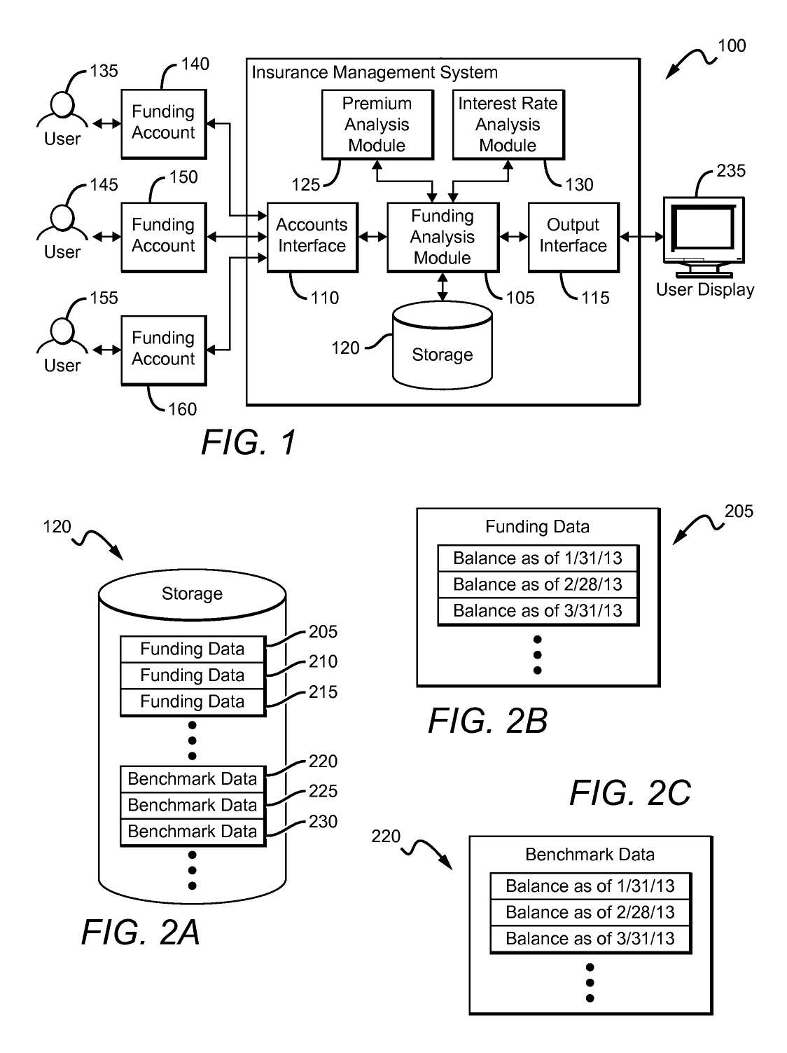

In one aspect of the invention, a system for determining/modifying a future premium of a life insurance policy is presented. FIG. 1 conceptually illustrates an example insurance management system 100 that is configured to determine and modify future premiums for permanent life insurance policies. In FIG. 1, the insurance management system 100 includes a funding analysis module 105, an accounts interface 110, an output interface 115, a storage 120, a premium analysis module 125, and an interest rate analysis module 130. In some embodiments, the output interface 115 may be connected to a user display 235 (e.g. computer monitor, portable computing device, etc.) In some embodiments, the storage 120 is non-transitory permanent data storage such as a hard drive, a flash memory, etc. The storage 120 may store data related to a plurality of insurance policies. Such data may include history of policy account payments on the policy, history of policy account balances over time, etc. In some embodiments, the funding analysis module 105, the accounts interface 110, the output interface 115, the premium analysis module 125, and the interest rate analysis module 130 are software modules that are executed by a set of processing units (e.g., processor, processing core, etc.) to perform the functions described herein. In some embodiments, the funding analysis module 105 may be configured to analyze historic funding data associated with the life insurance policy and compute a variable of the life insurance policy based on the analysis of the historic funding data.

In some embodiments, the insurance management system 100 manages different life insurance policies. Each life insurance policy is associated with an insurer (i.e., an insurance carrier), a policyholder, an insured, and a beneficiary. The policyholder is responsible to pay the insurer a payment on a periodic basis to keep the insurance policy in force. In return, the insurer promises to pay a sum of money to the beneficiary upon the death of the insured. As mentioned above, some life insurance policies (e.g., permanent life insurance policies) are associated with a funding account that accumulates cash value for the policyholder. For these types of policies, when the policyholder makes a payment to the insurer, the insurer takes a portion of the payment to cover the premium, and the remaining portion of the payment is directed to this funding account. The value that is accumulated in this funding account represents a cash value for the policy, from which the policyholder can withdraw, borrow, or retrieve money.

In some embodiments, the policyholder has the flexibility to decide how much payment to make in each pay period, as long as the funding account associated with the policy has enough cash value to sufficiently pay for the premium to maintain the insurance policy in force. In one example, for a life insurance policy with a monthly cost of insurance of $10,000, the policyholder pays $15,000 for the first month. The insurer will take $10,000 from the $15,000 as the premium, and put the remaining $5,000 in the funding account associated with the policy. For the second month, the policyholder continues to pay $15,000. Similar to the first month, the insurer takes $10,000 from the $15,000 as the premium, and puts the remaining $5,000 in the funding account. At this point, the funding account has a balance of $10,000. For the third month, the policyholder decides to pay $5,000, which is acceptable to the insurer because the payment and the balance of the funding account together are sufficient to cover the premium for the third month. Thus, the insurer takes the $5,000 payment that the policyholder pays and another $5,000 from the funding account to cover the premium. The funding account now has a balance of $5,000.

As one can see, a policyholder can make different amounts of payments from one month to the next, and resulting in varying cash values (i.e., balances) in the funding account from month to month.

In some embodiments, the accounts interface 110 of the insurance management system 100 is communicatively coupled to the funding accounts 140, 150, and 160 that are associated with their corresponding life insurance policies. Policyholders 135, 145, and 155 make insurance payments on a periodic basis, and at least a portion of the payments is directed toward the funding accounts 140, 150, and 160. In some embodiments, the accounts interface 110 is configured to monitor the activities (e.g., deposit by the policyholder, withdrawal for paying the premium, borrowing by the policyholder, etc.) of the funding accounts 140, 150, and 160. When the accounts interface 110 detects an activity to one of the accounts, the accounts interface 110 sends the activity information to the funding analysis module 105. The funding analysis module interprets and organizes the received funding data and store the data in the storage 120.

Different embodiments provide different implementations that allow the accounts interface 110 to detect activities of the funding accounts 140, 150, and 160. In some embodiments, each of the funding accounts may comprise a computing device that is connected to the accounts interface 110 via a network (e.g., Local Area Network (LAN), Wide Area Network (WAN), the Internet, etc.).

In some embodiments, the connection between accounts interface 110 and the funding accounts 140, 150, and 160 is asynchronous. In these embodiments, the funding accounts 140, 150, and 160 are configured to send a notification that comprises the activity information whenever a funding activity occurs. In other embodiments, the connection between accounts interface 110 and the funding accounts 140, 150, and 160 is synchronous. Thus, the accounts interface 110 is configured to receive update of any new account activity from the funding accounts periodically (e.g., every minute, every five minute, etc.).

As an example, accounts 140, 150, and 160 has the following activities. Policyholder 135 makes an insurance payment of $5,000, of which $3,000 goes to the funding account 140, policyholder 145 makes an insurance payment of $3,000, of which $1,000 goes to the funding account 150, and policyholder 155 makes an insurance payment of $4,000, of which $2,000 goes to the funding account 160. The accounts interface 110 detects these activities and sends information related to the activities to the funding analysis module 105. Upon receiving the information, the funding analysis module 105 organizes the data along with other historic funding data related to the accounts. In some embodiments, the historic funding data for accounts 140, 150, and 160 is stored in the storage 120.

FIGS. 2A-2C illustrates example funding data that may be stored in the storage 120. Specifically, FIG. 2A illustrates the storage 120 storing funding data 205, 210, and 215 for funding accounts 140, 150, and 160, respectively. In some embodiments, funding data comprises historic and current account balances over a period of time (e.g., balances since the time the insurance policy is in force). The funding data can include balances of the corresponding account at different times (e.g., the beginning or the end of each day, at the beginning or the end of each month, etc.). FIG. 2B shows that funding data 205 includes the balance of account 140 as of Jan. 31, 2013, the balance of account 140 as of Feb. 29, 2013, the balance of account 140 as of Mar. 31, 2013, and so forth. Although not shown in this figure, the funding data may include account payment history data or other information of the activities related to account 140 (e.g., time of deposit, amount of deposit, time of withdrawal, amount of withdrawal, reason for withdrawal, etc.).

Therefore, upon receiving a new account activity data (e.g., a new deposit in the amount of $3,000 for account 140), the funding analysis module 105 incorporates this new data into the funding data. For example, the funding analysis module 105 may calculate the new account balance for the account 140 based on the historic funding data stored in the storage 120 and the new account activity data. After determining the new balance, the funding analysis module 105 saves the new balance as part of the funding data 205, records payments and other related data, and stores the updated funding data 205 back to storage 120.

In addition to funding data 205, 210, and 215, the storage 120 of some embodiments also store benchmark data 220, 225, and 230, which corresponds to accounts 140, 150, and 160, respectively. In some embodiments, benchmark data for each account includes benchmark account payments and/or balances for different times during the coverage term of the life insurance policy. As shown in FIG. 2C, benchmark data 220 includes benchmark account payment/balance for Jan. 31, 2013, benchmark account payment/balance for Feb. 29, 2013, benchmark account payment/balance for Mar. 31, 2013, and so forth.

In some embodiments, the benchmark data for an account can represent payments and/or balances that the insurer expects (or desires) that the policyholder can maintain in the funding account at different times during the term of the policy. In addition, the benchmark data can be used to provide an indication of the policyholder's financial stability. For example, a funding account having an actual payment/balance that is above the benchmark data can indicate that the policyholder is more financially favorable (and more favorable), while a funding account having an actual payment/balance that is below the benchmark balance can indicate that the policyholder is less financially favorable (and less favorable).

In some embodiments, the benchmark data for different times (e.g., at the end of each month) of a life insurance policy's term is determined at the inception of the policy. The benchmark data can be determined based on different factors. Examples of the factors that affect the benchmark data of a policy include attributes of the insured of the policy, such as an age of the insured, a gender of the insured, a tobacco use of the insured, a health status of the insured, etc. Once the benchmark data is determined for a policy, they are saved as in the storage 120.

In some embodiments, each of the benchmark payments or balances may also include a range value (e.g. a ceiling value and a floor value). The ceiling and floor values represent a threshold range. In these embodiments, and in addition to the value of the benchmark payments or balances, there may be a pair of a ceiling and a floor value that correspond to each of the benchmark payments and balances. Whereupon, these ceiling and floor values may also be a factor in determining the favorability of a policyholder. Specifically, by taking into consideration where the actual payments or balances on the account stand relative to the ceiling and floor values.

It is contemplated that the favorability of a policyholder can vary from time to time depending on the actual payments or balances of the funding account. If the policyholder increases the contribution to the account such that the actual payment/balance of the account is above (or much higher than) the benchmark data, the policyholder's favorability will increase. Conversely, if the policyholder reduces the contribution over time such that the actual payment/balance of the account is below the benchmark data, the policyholder's favorability will decrease.

The funding analysis module 105 of some embodiments determines the favorability of a policyholder by comparing the actual payment(s) or balance(s) of an account associated with the policyholder against the benchmark data for the account. In some embodiments, the funding analysis module 105 makes this determination by comparing only the actual current payment or balance of the account against the current benchmark for the account (to generate a delta). In other embodiments, the funding analysis module 105 makes this determination by comparing the historic payments or balances (current and previous payments or balances at different times in the past) of the account against the current and past benchmarks for the account. In yet other embodiments, the funding analysis module 105 makes the determination by analyzing both the actual current payment and actual balance of the funding account. The funding analysis module 105 can generate an accumulated delta that represents the sum of the differences between the actual balances and the benchmark balances.

TABLE 1
Examples of actual vs. benchmark payments

| | Jan. 31, 2013 | Feb. 28, 2013 | Mar. 31, 2013 | Totals |
|---|---|---|---|---|
| Actual | $20,000 | $5,000 | $10,000 | $35,000 |
| Payment | | | | |
| Benchmark | $15,000 | $15,000 | $15,000 | $45,000 |
| Payment | | | | |
| Δ Payment | $5,000 | −$10,000 | −$5,000 | −$10,000 |
| Actual | $15,000 | $15,000 | $20,000 | N/A |
| Balance | | | | |
| Benchmark | $10,000 | $20,000 | $30,000 | N/A |
| Balance | | | | |
| Δ Balance | $5,000 | −$5,000 | −$10,000 | N/A |

Table 1 illustrates an example where the benchmark data is non-variable (i.e. the benchmark payment and balance expectation for each month does not change during the policy term based on the favorability of the policyholder). In this example, the policyholder has a strong start by meeting and exceeding the benchmark payment and balance for the month of January, 2013. The policyholder makes a payment of $20,000 by the end of January, 2013, where the required payment is $15,000 and the required balance is $10,000 (as discussed, the difference of $5,000 is used to pay the policy premium in this case). Therefore, for the month of January, 2013, the favorability rating of the policyholder is strong. However, for the month of February, 2013, the policyholder falls behind the expected payment and balance benchmark, by making a payment of $5,000. Thereupon, the policyholder's favorability sharply declined by the end of February, 2013 (Δ Payment=−$10,000 and Δ Balance=−$5,000). As illustrated, it depends on which number the insurer considers, if not both, the policyholder may hold a higher or lower favorability rating if the Δ Payment is used as opposed to the Δ Balance. By the end of March, 2013, the policyholder favorability rating took another tumble, though not as much as in February, 2013, since the policyholder made a payment of $10,000. This payment satisfies the $5,000 premium payment and the remainder $5,000 is added to the balance of the policy account. Nevertheless, since the payment still fell short of the benchmark payment of $15,000 and the account balance did not meet the benchmark balance, the policyholder's favorability rating remained low. Based on the favorability level of the policyholder, the insurance management system 100 can modify/adjust the future premiums of the policy. Higher favorability level allows for reducing future premium amounts and/or increasing future interest rates of the account. Similarly, lower favorability level allows for increasing future premium amounts and/or reducing future interest rates of the account.

As mentioned, it is also contemplated that ceiling and floor values be a factor in determining the policyholder's favorability. For example, the policyholder may have a higher favorability rating if the actual payments or balances fall within range of the benchmark data values and the ceiling values, as compared to having payments or balances that exactly meet the benchmark data values for either payments or balances. In this example, the policyholder exceeds the benchmark expectations, and thus demonstrates stability and financial strength as opposed to only meeting the benchmark requirements. Similarly, the policyholder may have a higher favorability rating if the actual payments and balances fall below the benchmark data values but higher than the values, as compared to having payments or balances that fall lower than the floor values. This is another example of distinguishing between different policyholders based on the patterns of their account funding activities, where in this case the policyholder's favorability will not be made to suffer as much if it says within a given range of the expected benchmark for payments or balances.

In addition, the funding analysis module 105 can put different weights to different comparisons. For example, more weights can be given to comparisons of more current balances, and less weight can be given to comparisons of balances further away in the past.

As discussed, the funding analysis module 105, of some embodiments, generates a funding analysis for the policyholder based on the comparison(s) between the actual payment(s) or balance(s) and the benchmark data of the account. In some embodiments, the funding analysis may comprise a favorability score. After analyzing the funding level of an account, the funding analysis module 105 sends the funding analysis to the premium analysis module 125 and the interest rate analysis module 130.

In some embodiments, the premium analysis module 125 determines a future premium for a life insurance policy based on the funding analysis of the account associated with the policy. For example, the premium analysis module 125 can determine a discount to the future premium when the funding analysis indicates that the policyholder is favorable (e.g., the actual payment(s) or balance(s) is higher than the benchmark data), and determine a surcharge to the future premium when the funding analysis indicates that the policyholder is unfavorable (e.g., the actual payment(s) or balance(s) is lower than the benchmark data). The funding analysis module 105 may then configure an output device (e.g., the user display 235) to present the updated future premium to a user via the output interface 115.

Similarly, the interest rate analysis module 130 of some embodiments determines a future interest rate for a funding account based on the funding analysis of the account. For example, the interest rate analysis module 130 can determine a higher future interest rate (higher than the current interest rate, or higher than the standard interest rate) when the funding analysis indicates that the policyholder is favorable (e.g., the actual payment(s) or balance(s) is higher than the benchmark data), and determine a lower future interest rate (lower than the current interest rate or lower than the standard interest rate) when the funding analysis indicates that the policyholder is unfavorable (e.g., the actual payment(s) or balance(s) is lower than the benchmark data). The funding analysis module 105 may then configure an output device (e.g., the user display 235) to present the updated future interest rate to a user via the output interface 115.

In some cases, a policyholder can hold more than one life insurance policy. As such, the funding analysis module of some embodiments can determine the favorability of the policyholder by analyzing all accounts associated with the policies held by the same policyholder. In these embodiments, the policyholder's actions with respect to one account can affect a future cost of insurance and/or a future interest rate for other accounts held by the policyholder.

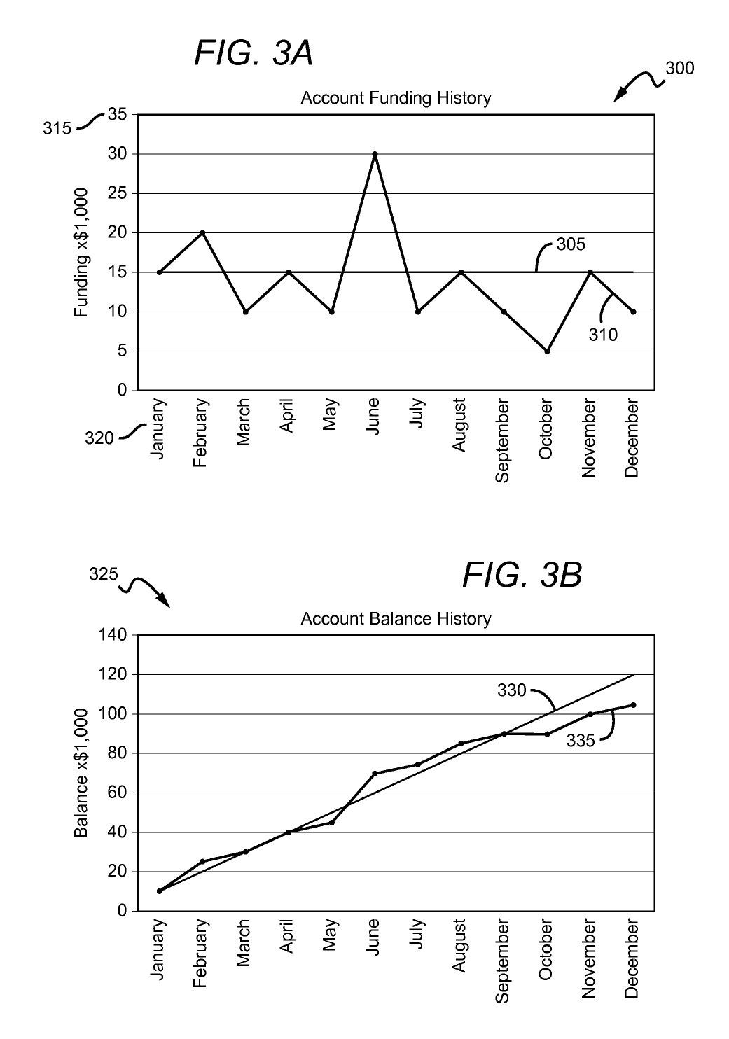

FIG. 3A illustrates an example payment and account balance history for a typical favorable policyholder. Specifically, FIG. 3A is an account funding history chart 300 for the typical policyholder. As shown, the account funding history chart 300 provides a recordation of the history of payments made on the policy account, in a dollar amount 315 of the multiples of a thousand dollars (×$1,000). Also, the account funding history chart 300 records that history of payments over a time period, in this case over each of the months 320 of the year 2013. Also shown, is the benchmark payment value 305 set on this policy account, as previously discussed. In the example illustrated by FIG. 3A, the benchmark monthly payment amount is fifteen thousand dollars ($15,000) as indicated by the horizontal chart line 305. Each recorded funding data is represented by one of multiple dots that are connected by chart line 310. Each recorded payment represents the funding activity for each of the months of January through December, 2013.

FIG. 3A illustrates an example the payment behavior of a typical favorable policyholder. As shown, the favorable policyholder makes four payments that meet the set benchmark payment amount 305 ($15,000). The four payments are for the months of January, April, August, and November. The favorable policyholder makes six payments that fall below the benchmark payment amount. These payments were for the months of March, May, July, September, October, and December. However, since the premium payment amount on this is $5,000, the policyholder always manages to pay each of the premium payments for the year 2013. Additionally, the policyholder makes two payments that exceed the benchmark payment amount for each of the months of February and June. With the payment of the month of June being double that of the benchmark payment amount, the policyholder is able to balance out his payments on the account, thereby shows the necessary financial stability to earn favorability with the insurer.

FIG. 3B illustrates the reflection and effect of the payment activity of a favorable policyholder on the policy account balance history 325. Similar to FIG. 3A, FIG. 3B illustrates the balance history of the policy account by tracking the balance in a dollar amount of multiples of a thousand dollars 315 ($1,000), in relation to each month for a given time period 320 (for the year 2013 in this case). As shown in FIG. 3B, the balance benchmark 330 of the policy account sets the expectation of a steady balance increase in the amount of $10,000 at the end of each month. As in FIG. 3A, the account balance history 335 is represented by the chart line connecting the dot of each of the twelve months of the year 2013. Each dot records the account balance at the end of each month. In FIG. 3B, the policy term begins on Jan. 1, 2013, where the policy account balance is recorded at zero dollars. By the end of January, 2013, and after a first payment in the amount of $15,000, the policy account is recorded as $10,000 (after subtracting the premium amount ($5,000) from the first payment). As a result of the payment behavior of the policyholder (as shown in FIG. 3A), the account balance history 335 of FIG. 3B does not deviate much from the balance benchmark 330. This is also an indication of the financial stability of the policyholder, which results in the favorable rating of the policyholder in this case by the insurer.

FIG. 3B shows that the account balance met the set expectations according to the balance benchmark 330 at the end of January, March, April, and September. Even though the account balance fell below the expected balance benchmark 330 for the month of May, October, and November, the funding analysis module 105 will also consider that the balance exceed expectations on the remaining four month of the year (February, June, July, and August). The funding analysis module 105 may consider the cumulative account balance history 335 when determining the favorability of the policyholder. In the example illustrated by FIG. 3B, the policyholder shows the ability to meet the account balance obligation called for by the balance benchmark 330 for eight out of the twelve months of the year 2013. However, considering that the account balance fell below the expected balance benchmark amount for the last three months of 2013, the insurer may decide to keep the policyholder at a favorable rating, but closely monitor the account balance for the beginning of the next year (2014).

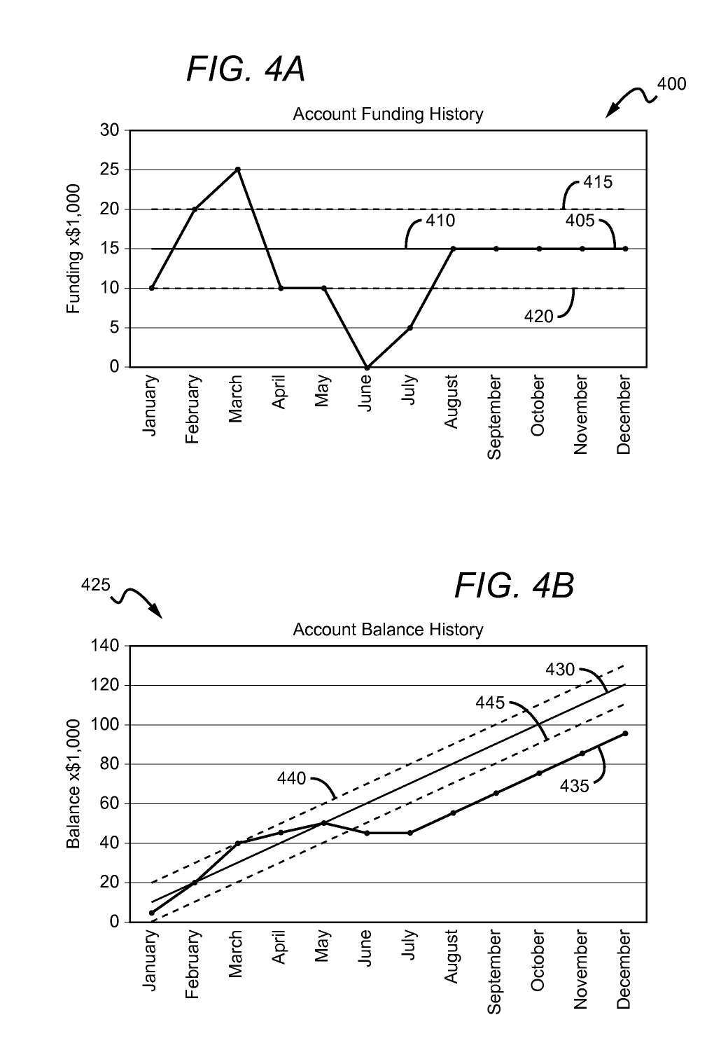

It is also contemplated that the funding analysis module 105 may have an exhaustive policyholder favorability ranking In these embodiments, the funding analysis module 105 may be able to assess the favorability of different policyholders in a more detailed fashion. FIG. 4A illustrates one of the tools the funding analysis module 105 may utilize to conduct a more exhaustive policyholder favorability ranking FIG. 4A, shows an account funding history 400 of another policy account. As shown, the policy account of FIG. 4A has a funding benchmark 410 and an account funding activity 405, similar to that of FIG. 3A. Additionally, FIG. 4A shows a benchmark threshold range that may be utilized by the funding analysis module 105. The benchmark threshold range may have a threshold funding ceiling 415 and a threshold funding floor 420.

The funding analysis module 105 may put a first policyholder at a higher favorability ranking when the account funding history of the first policyholder shows a steady resemblance to the account funding benchmark. Further, the funding analysis module 105 may put a second policyholder at a lower favorability ranking to that of the first policyholder, if the account funding history of the second policyholder shows funding activity that might not resemble the account funding benchmark, but one that stays within the account funding threshold range. Furthermore, the funding analysis module 105 may put a third policyholder at a lower favorability ranking to that of the first and second policyholders, if the account funding history of the third policyholder shows funding activity that might tend to fall below the funding threshold floor. Additionally, the funding analysis module 105 may hold an especially higher favorability ranking for any policyholder with an account funding history that might tend to fall at or above the funding threshold ceiling, even higher than the favorability ranking of the first policyholder.

Accordingly, FIG. 4A shows an example of an account funding history 400 of a policyholder that the funding analysis module 105 may evaluate not only in relation to the account funding benchmark 410, but also in relation to the account funding threshold ceiling 415 and floor 420. In the example shown in FIG. 4A, the account funding activity 405 of the policyholder meets the benchmark 410 goal for the months of July through December, 2013 (for half the year of 2013). The policyholder manages to exceed the funding benchmark 410 goal for the months of February and March, 2013. However, the policyholder fell below the funding benchmark 410 for the months of April, May, June, and July, 2013 (four months).

On the surface, and without taking into consideration the threshold ceiling and floor marks, the favorability of the policyholder of FIG. 4A might not be that much different than that of the policyholder of FIG. 3A (when balancing out their funding activity throughout the year 2013). However, if we introduce the threshold range into the assessment process, the insurer will be able to distinguish more clearly between the two policyholders in terms of their favorability.

As shown in FIG. 4A, the policyholder stayed within the funding activity threshold for all but three months of the year (March, June, and July). Only one month's funding activity exceeded the funding threshold ceiling of $20,000 (for the month of March). However, there were two month where the policyholder's funding activity fell below the funding threshold floor of $10,000 (for the months of June and July). Further, for the month of June, the policyholder did not actually make a payment on the policy account, which resulted in missing the premium payment on the account for that month. Thus, utilizing the threshold ceiling and floor values as measuring point of the funding activity provides more accurate tool to distinguish between the funding activities of policyholders.

FIG. 4B shows the account balance history 425 prospective for the policy account of the policyholder of FIG. 4A. As shown, the account balance history 425 includes a balance benchmark 430, and a set of account balances 435 for each month in the year 2013. The balance benchmark is expected to increase by $10,000 at the end of each month, starting with a balance of zero dollars at the creation of the policy account. Additionally, and similar to FIG. 4A, the account balance history 425 include an account balance threshold ceiling 440, and an account balance threshold floor 445. The account balance threshold ceiling 440 is expected to be $10,000 higher than balance benchmark 430 at any point in time. Also, the account balance threshold floor 445 is expected to be $10,000 lower than the balance benchmark 430.

In FIG. 4B, the account balance 435 stays close to the level expected by the balance benchmark 430, being lower than the balance by no more than $20,000 at any point in time. If the funding analysis module 105 bases the favorability ranking on the account balance benchmark 430, the policyholder of FIG. 4A will rank lower than the policyholder of FIG. 3A. However, if the funding analysis module 105 takes the account balance threshold ceiling and floor into consideration, the policyholder of FIG. 4A may have a much lower favorability ranking than first assessed. The reason for the potential favorability ranking deterioration is having an account balance 435 falling not only below the account balance benchmark 430, but also below the balance threshold floor 445 for the last six month of the year 2013 (July through December of 2013).

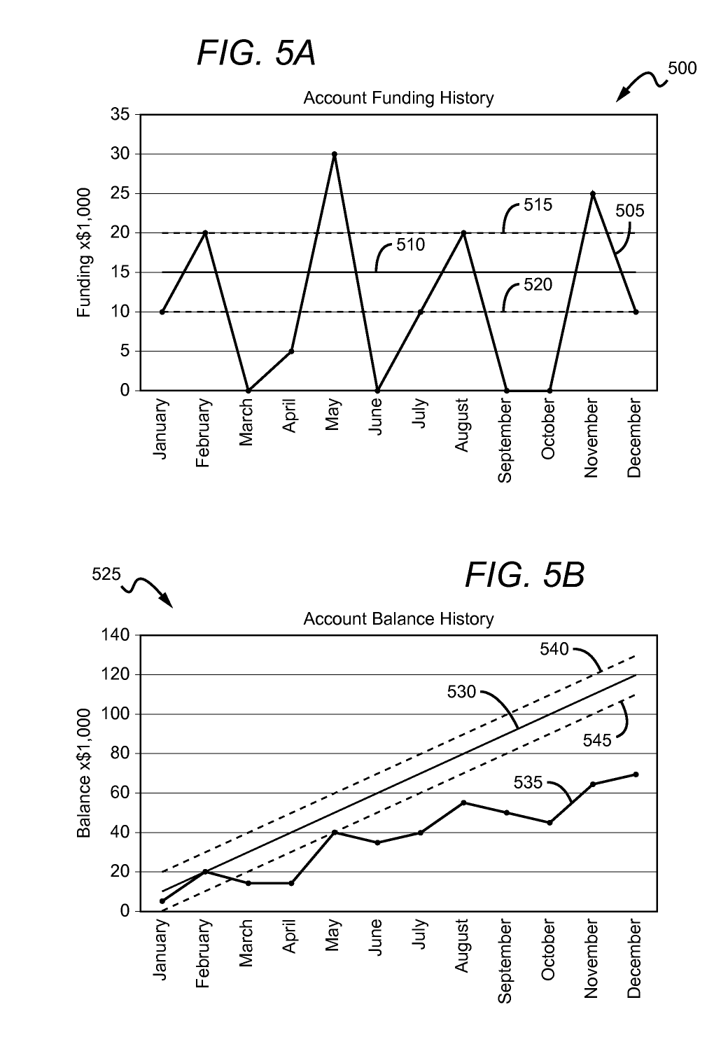

FIG. 5A illustrates a third exemplary policy account activity. FIG. 5A shows the account funding history 500 of this third example. As shown, the benchmark funding amount 510 is set at $15,000 per month, with the funding threshold ceiling 515 and floor 520 set at $20,000 per month and $10,000 per month respectively. Also, FIG. 5A shows the funding activity 505 of the policyholder. In this example, we note that the policyholder made payments that are lower than the funding threshold floor 520 for almost half of the year 2013 (for the months of March, April, June, September, and October). With four of these month having payments in the amount of zero dollars, thus missing the premium payments on the policy. Further, if other monthly payment falling below the funding benchmark 510 are added, this policyholder would be shown to have a funding history below the funding benchmark 510 for 10 months, i.e. most of the year 2013 (adding the months of January, July, and December).

FIG. 5B, shows the account balance history 525 of this third example. As shown, the balance benchmark 530 is set to start at $10,000, with the balance threshold ceiling 540 and floor 545 set to start at $20,000 and $0 respectively. Also, FIG. 5B shows balance history 535 on the account. As shown, the balance history 535 on the account falls below the threshold floor 545 for 9 out of the 12 months of the year. Further, the balance history 535 on the account shows steady deterioration, i.e. falling further behind the set balance benchmark 530, from June to December, 2013. The insurer in this case may already have a good indication, just looking at the charts of FIG. 5A and FIG. 5B, that the policyholder of FIG. 5A will hold a lower favorability ranking score than that of the policyholder of FIG. 4A.

The funding analysis module 105 may use the data provided by the account funding history charts 300 400 500 to conduct an evaluation of the account funding history of any given policyholder. The funding analysis module 105 may have a ranking scale on which the policyholder may be placed based on earned ranking points. Each recorded data on the account funding history chart may earn the policyholder a specific value of ranking points, depending on where the recorded data falls relative to the corresponding threshold ceiling, benchmark, and the threshold floor points.

As an example, the funding analysis module 105 may be configured to have a scale of 0 to 36 point to measure the favorability of a policyholder. In this example, the funding analysis module 105 may grant the policyholder 3 points for each recorded data more than or equals to the threshold ceiling, 2 points for each recorded data more than or equals to the benchmark, 1 point for each recorded data more than or equals to the threshold floor, and zero points to any recorded data less than the threshold ceiling.

Based on the recorded data of FIG. 4A, the funding analysis module 105 may grant the policyholder three points for each of the months of February and March (totaling 3×2=6 points). The funding analysis module 105 may also grant the policyholder two points for each of the months August, September, October, November, and December (totaling 2×5=10 points). Further, the funding analysis module 105 may grant the policyholder one point for each of the months of January, April, and May (totaling 1×3=3 points) Thus, the policyholder of FIG. 4A may have a ranking score of 19 points (6+10+3=19 points).

Based on the recorded data of FIG. 5A, the funding analysis module 105 may grant the policyholder three points for each of the months of February, May, August, and November (totaling 3×4=12 points). The funding analysis module 105 may also grant the policyholder one point for each of the months January, July, and December (totaling 1×3=3 points). Thus, the policyholder of FIG. 5A may have a ranking score of 15 points (12+3=15 points).

The funding analysis module 105 may utilize the premium analysis module 125 and the interest rate analysis module 130 to determine a schedule of different pairs of premiums and interest rates based on the favorability ranking score of a given policyholder. In the case of the exemplary policyholders of FIG. 4A and FIG. 5A, the funding analysis module 105 may use the translated favorability ranking scores to set the premiums and interest rates for each policyholder at the end of the policy term (end of year 2013), to apply for the policy term (year 2014).

In some embodiments, the funding analysis module 105 may not defer adjusting the premiums and interest rates on some of the policies to the end of policy term. Specifically, the funding analysis module 105 may determine the favorability of a given policyholder, as discussed above, at the end of each month. In these embodiments, the funding analysis module 105 may be raise or lower the premiums and interest rates (along with adjusting the account policy benchmarks and thresholds) based on the determined favorability ranking score.

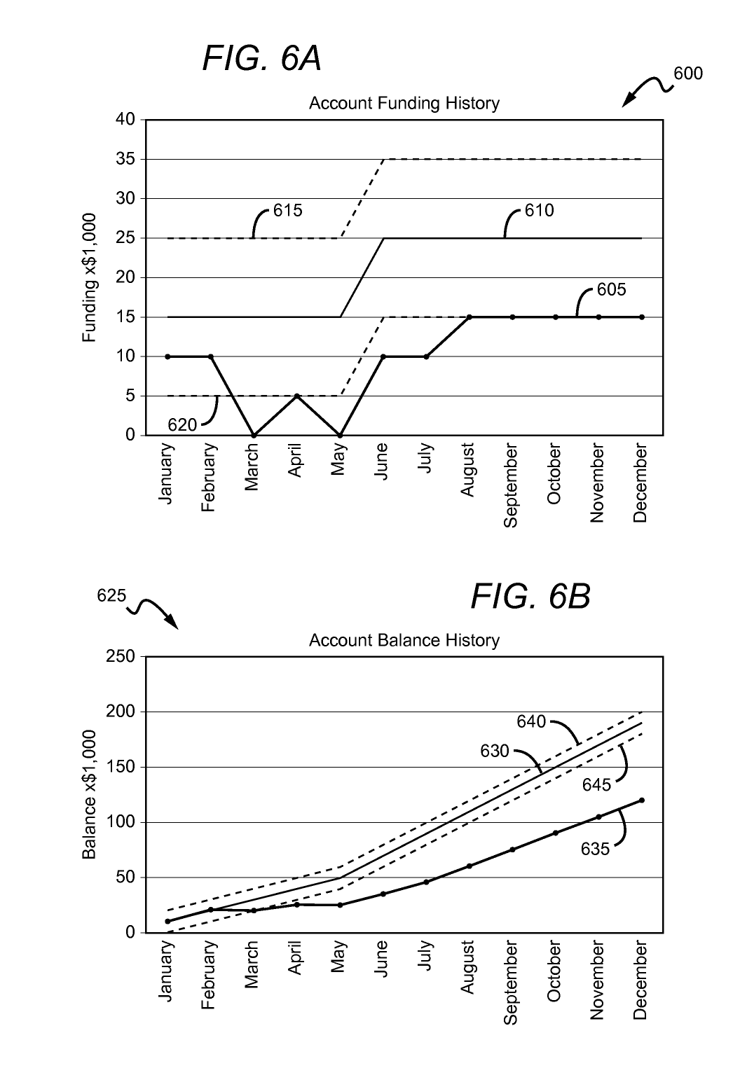

FIG. 6A, illustrates an example where the funding analysis module 105 adjusts the premium and interest rates, and the benchmark and threshold values set on the policy account prior to the end of the policy term. FIG. 6A shows the account funding history 600. As shown, at the beginning of the year 2013, the benchmark funding amount 610 is set at $15,000 per month, with the funding threshold ceiling 615 and floor 620 set at $20,000 per month and $10,000 per month respectively. Also, FIG. 6A shows the funding activity 605 of the policyholder.

In this example, we note that the policyholder never met the set funding benchmark (set at $15,000 per month). Rather the policyholder makes two payments for $10,000 on the account for the months of January and February. For the following three months (March, April, and May) the policyholder makes payments that are less than or equal to the funding threshold floor ($5,000). Further, the policyholder did not even make a payment for the months of March and May.

The funding analysis module 105 in this case may record the funding performance of the policyholder. Thus, the funding analysis module 105 may start to closely monitor the policy account, and to conduct a favorability evaluation of the policyholder after the end of each month. At the point where the policyholder fails to make a payment on the account for the second month (for the month of May) the funding analysis module 105 may adjust the premiums and interest rates along with raising the funding benchmark 610, and the funding threshold ceiling 615 and floor 620. In this example, the funding analysis module 105 raises the funding benchmark 610 from $15,000 per month to $25,000 per month. Also, the funding threshold ceiling and floor values rise from $25,000 and $5,000 per month to $35,000 and $15,000 per month respectively.

It is also noted that the policyholder's funding activity begins to stabilize by making steady payments of $15,000 per month for the last five months of the year 2013. This indicates that the policyholder recognized the consequences of not fulfilling the policy account funding obligations, and reacted at the very least by making steady payments for a good portion of the remainder of the year.

FIG. 6B shows an account balance history 625 of the account policy for the policyholder of FIG. 6A. As shown, the account balance history 625 parts ways with the balance benchmark 630 after the month of February. Also, shown how the gap between the account balance 635 and the balance benchmark 630 continues to increase as the months passes. That in spite of the policyholder's steady payments for the last five months of the year. This is attributed to the adjustments the funding analysis module 105 made to the balance benchmark 630 after the month of May, which raised the bar of expected policy account funding and balance.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for determining a future premium of a life insurance policy, the system comprising a premium analysis module configured to:
analyze historic funding data associated with the life insurance policy;
compute the future premium for the life insurance policy based in part on the analysis of the historic funding data; and
configure an output device to present the computed future premium to a user.

2. The system of claim 1, wherein the life insurance policy is associated with a funding account, wherein the historic funding data for the life insurance policy comprises balances of the life insurance policy's funding account at different points in time.

3. The system of claim 2, wherein the premium analysis module is further configured to compare a current one of the balances of the life insurance policy's funding account with a predetermined current benchmark funding level.

4. The system of claim 3, wherein the premium analysis module is further configured to compute a discount to the future premium when the current balance is equal to or above the current benchmark funding level.

5. The system of claim 3, wherein the premium analysis module is further configured to compute a surcharge to the future premium when the current balance is below the current benchmark funding level.

6. The system of claim 3, wherein the current benchmark funding level is predetermined based on at least one characteristic of an insured of the life insurance policy.

7. The system of claim 6, wherein the at least one characteristic comprises a gender of the insured.

8. The system of claim 6, wherein the at least one characteristic comprises an age of the insured.

9. The system of claim 6, wherein the at least one characteristic comprises a tobacco use level of the insured.

10. The system of claim 6, wherein the at least one characteristic comprises a health status of the insured.

11. The system of claim 3, wherein the current benchmark funding level is predetermined based on at least one attribute of the life insurance policy.

12. The system of claim 11, wherein the at least one attribute comprises a benefit amount of the life insurance policy.

13. The system of claim 2, wherein the premium analysis module is further configured to compare the balances of the life insurance policy's funding account to a plurality of benchmark funding levels that are pre-determined for the life insurance policy.

14. The system of claim 13, wherein the plurality of benchmark funding levels represent expected funding levels at different times during a term of the life insurance policy.

15. The system of claim 2, wherein the premium analysis module is further configured to generate trend data based on the historic funding data, and wherein the future premium is computed based in part on the generated trend data.

16. The system of claim 1, wherein the system further comprises a database storing the historic funding data of the life insurance policy and historic funding data of a second life insurance policy.

17. The system of claim 16, wherein the life insurance policy and the second life insurance policy have a same policyholder, wherein the premium analysis module is further configured to analyze the historic funding data of the second life insurance policy and to determine the future premium based in part on the analysis of historic funding data of the life insurance policy and the analysis of historic funding data of the second life insurance policy.

18. The system of claim 16, wherein the life insurance policy and the second life insurance policy have different policyholders.

19. A system for determining a future interest rate of a life insurance policy, the system comprising an interest rate analysis module configured to:
analyze the historic funding data associated with the life insurance policy;
compute the interest rate for the life insurance policy based in part on the analysis of the historic funding data; and
configure an output device to present the computed future interest rate to a user.

20. The system of claim 19, wherein the life insurance policy is associated with a funding account, wherein the historic funding data for the life insurance policy comprises balances of the life insurance policy's funding account at different points in time.
